(19) United States
(12) Patent Application Publication
(10) Pub. No.: US 2021/0260650 A1
(43) Pub. Date: Aug. 26, 2021

(54) ADDITIVE MANUFACTURING POWDER AND ADDITIVE MANUFACTURING PART MADE USING SAME

(71) Applicant: EQUISPHERES INC., Ottawa (CA)

(72) Inventors: Martin John COLON, Ottawa (CA); Douglas Andrew BROUSE, Ottawa (CA); Sean Robert DOUTRE, Ottawa (CA); Shengze YIN, Ottawa (CA); Jonathan PHILLIPS, San Juan Capistrano, CA (US)

(73) Assignee: Equispheres Inc., Ottawa, ON (CA)

(21) Appl. No.: 17/053,826

(22) PCT Filed: May 10, 2019
(86) PCT No.: PCT/CA2019/050634

§ 371 Date: Nov. 9, 2020

Related U.S. Application Data
(60) Provisional application No. 62/670,454, filed on May 11, 2018.

(51) Int. Cl. B22F 1/00; B33Y 70/00; C22C 21/02

(52) U.S. Cl. CPC B22F 1/0011; B33Y 10/00; C22C 21/02; B33Y 70/00

(57) ABSTRACT

A powder composition for use in additive manufacturing, related metal-based particles, related methods and related consolidated part. The composition consisting of metal-based particles and a remainder representing at most 10 wt % of a total weight of the composition, which can be at least one of a ceramic, a lubricant and a binder. The metal-based particles are highly spherical and can be considered fines-free. More particularly, less than 8,000,000 of the metal-based particles per gram of the metal-based particles have a diameter smaller than or equal to 15 μm; and the metal-based particles have at least one of an average aspect ratio greater than or equal to 0.95; an average roundness greater than or equal to 0.95; and an average Krumbein sphericity greater than or equal to 0.95.

### TECHNICAL FIELD OF THE INVENTION

The technical field generally relates to a metal-based powder for additive manufacturing processes. More specifically, it relates to a metal-based additive manufacturing powder including metal-based particles being characterized by a combination of specific physical and chemical properties being suitable for deposition in layers or for forming through powder metallurgy processes. It also relates to parts made by additive manufacturing using the additive manufacturing powder.

### BACKGROUND

Additive manufacturing (AM) technologies encompass manufacturing processes in which metal, polymer and various other materials are deposited, cured, melted or sintered in layers according to a digital model. Metal AM processes include, for instance, directed energy deposition, cold spray and powder bed fusion, and generally use material feedstock in the form of filament, wire or powder. For instance, directed energy deposition is a process using a source of thermal energy focused on a feedstock material (such as powder or wire) that is melted as it is deposited on a substrate or existing part. Cold spray involves accelerating powder particles at supersonic velocities (400-1000 m/s) and projecting the particles onto a substrate onto which they adhere due to their plastic deformation. This process is generally used for repairs and coatings. Powder bed fusion refers to processes using a thermal energy source such as a laser, as in laser powder bed fusion (LPBF), or an electron beam to selectively fuse or melt powder particles of a powder bed. Successive layering and selective fusing or melting of the particles result in three dimensional consolidated parts.

Due to the layering process of AM, complex geometries can be obtained in contrast to traditional forming or subtractive manufacturing processes. A great potential of AM resides in enhanced functionality and weight reduction of the resulting parts. More particularly, alloys such as aluminum have shown to be of great interest in the AM sector, finding a niche in parts that cannot be produced through casting and forging routes. However, due to the lack of repeatability related to the quality of the AM powder feedstock, aluminum-based powders, for instance, are difficult to process in laser powder bed fusion.

In this context, quality of powder feedstock can refer to physical characteristics of powder particles such as size, shape, size distribution, thermal conductivity, electric conductivity and hardness. The quality of the powder feedstock also relates to its physical and chemical characteristics such as the powder composition and microstructure. These characteristics of the AM powder have an impact on the efficiency of the AM process as well as on the properties of the consolidated parts made using the powder.

Also, AM powders generally have to be stored and handled carefully to reduce or prevent uncontrolled variations in the oxygen and moisture (i.e. water and water vapor) content of the powder. Contaminated powder, i.e. powder exposed to an environment varying in oxygen and/or in moisture content, can result in degradation of the microstructure and poorer mechanical properties of the consolidated parts made using the powder. As particle size, particle shape, particle size distribution and surface contamination have an influence on the consolidated part quality and performance, reaching a balance with respect to these powder characteristics is a complex process.

In view of the above, there is a need for additive manufacturing powders that could be able to overcome or at least partly address some of the above-discussed concerns.

### SUMMARY

In one aspect, there is provided an additive manufacturing powder comprising metal based particles wherein less than 20, 000, 000 of the metal-based particles per gram of the metal-based particles have a diameter smaller than or equal to 15 μm; and the metal-based particles have at least one of:
a) an average aspect ratio greater than or equal to 0.95;
b) an average roundness greater than or equal to 0.95; and
c) an average Krumbein sphericity greater than or equal to 0.95.

In some implementations of the AM powder, less than 8, 000, 000 of the metal-based particles per gram of the metal-based particles have a diameter smaller than or equal to 15 μm.

In some implementations of the AM powder, less than 1,000,000 of the metal-based particles per gram of the metal-based particles have a diameter between]10,15] μm, less than 2,000,000 of the metal-based particles per gram of the metal-based particles have a diameter between [5,10] μm, and less than 5,000,000 of the metal-based particles per gram of the metal-based particles have a diameter smaller than 5 μm.

In another aspect, there is provided an additive manufacturing powder comprising metal-based particles wherein less than 1,000,000 of the metal-based particles per gram of the metal-based particles have a diameter between]10,15] μm, less than 2,000,000 of the metal-based particles per gram of the metal-based particles have a diameter between [5,10] μm, and less than 5,000,000 of the metal-based particles per gram of the metal-based particles have a diameter smaller than 5 μm; and the metal-based particles have:
a) an average aspect ratio greater than or equal to 0.95; and/or
b) an average roundness greater than or equal to 0.95; and/or
c) an average Krumbein sphericity greater than or equal to 0.95.

In some implementations of the AM powder, the additive manufacturing powder consists essentially of the metal-based particles.

In some implementations of the AM powder, less than 500,000 of the metal-based particles per gram of the metal-based particles have a diameter between]10,15] μm, less than 1,000,000 of the metal-based particles per gram of the metal-based particles have a diameter between [5,10] μm, and less than 3,000,000 of the metal-based particles per gram of the metal-based particles have a diameter smaller than 5 μm.

In some implementations of the AM powder, less than 300,000 of the metal-based particles per gram of the metal-based particles have a diameter between]10,15] μm, less than 700,000 of the metal-based particles per gram of the metal-based particles have a diameter between [5,10] μm, and less than 2,500,000 metal-based particles per gram of the metal-based particles have a diameter smaller than 5 μm.

In some implementations of the AM powder, the average aspect ratio of the metal-based particles is greater than or equal to about 0.971, optionally the average aspect ratio of the metal-based particles is greater than or equal to about 0.985, and further optionally the average aspect ratio of the metal-based particles is greater than or equal to about 0.9995.

In some implementations of the AM powder, the average Krumbein sphericity of the metal-based particles is greater than 0.95; optionally, the average Krumbein sphericity of the metal-based particles is greater than 0.999; and further optionally, the average Krumbein sphericity of the metal-based particles is greater than 0.9995.

In some implementations of the AM powder, the average Wadell roundness of the metal-based particles is greater than or equal to 0.95; optionally, the average Wadell roundness of the metal-based particles is greater than or equal to 0.991; and further optionally, the average Wadell roundness of the metal-based particles is greater than or equal to 0.995.

In some implementations of the AM powder, the metal-based particles of the powder have a dimensionless particle size distribution width greater than 10.

In some implementations of the AM powder, the metal-based particles of the powder have an average apparent density greater than or equal to 53%; optionally, the average apparent density is greater than or equal to 55%; and further optionally, the average apparent density is greater than or equal to 56%.

In some implementations of the AM powder, the powder has a ratio of an average spread density to the average apparent density greater than 90%; optionally, the average spread density to the average apparent density is greater than 95%; and further optionally, the ratio of the average spread density to the average apparent density greater than 97.5%.

In some implementations of the AM powder, the metal-based particles of the powder have a mass-median-diameter (d50) and at least 70 wt % of the metal-based particles of the powder are within 5 μm of the mass-median-diameter (d50) and/or at least 99.6 wt % of the metal-based particles of the powder are within 20 μm of the mass-median-diameter (d50).

In some implementations of the AM powder, 80 wt % of the metal-based particles are within about 5 μm of the mass-median-diameter (d50); optionally, at least 99.6 wt % of the metal-based particles of the powder are within 15 μm of the mass-median-diameter (d50); and further optionally, at least 99.6 wt % of the metal-based particles of the powder are within 10 μm of the mass-median-diameter (d50).

In some implementations of the AM powder, the mass-median-diameter (d50) is between 45 μm to 90 μm; alternatively and optionally, the mass-median-diameter (d50) is 125 μm.

In some implementations of the AM powder, the metal-based particles of the powder are characterized by a Hall flow lower than or equal to 40 seconds per 50 grams. Optionally, the Hall flow is lower than or equal to 32 seconds per 50 grams.

In some implementations of the AM powder, the metal-based particles of the powder are characterized by a Carney flow lower than or equal to 7 seconds per 50 grams.

In some implementations of the AM powder, the metal-based particles of the powder are characterized by a specific surface area between 0.02 and 0.2 m²/g.

In some implementations of the AM powder, the metal-based particles of the powder are aluminum-based.

In some implementations of the AM powder, the metal-based particles of the powder have an average degree of moisture sorption less than 0.006 wt %.

In some implementations of the AM powder, the metal-based particles comprise an outer metal oxide layer and an average thickness of the outer metal oxide layer of the metal-based particles is less than 5 nm.

In some implementations of the AM powder, the metal-based particles are formed by an atomization process.

In another aspect, there is provided a method for the preparation of a metal-based powder for use in additive manufacturing, the method comprising:
providing a bulk of metal-based particles;
identifying, among the bulk, spherical metal-based particles having at least one of:
   d) an average aspect ratio greater than or equal to 0.95;
   e) an average roundness greater than or equal to 0.95; and
   f) an average Krumbein sphericity greater than or equal to 0.95; and
mechanically separating the spherical metal-based particles to form the metal-based powder comprising less than 20,000,000 of the spherical metal-based particles per gram of the metal-based particles with a diameter smaller than or equal to 15 μm.

In another aspect, there is provided a method for the preparation of a metal-based powder for use in additive manufacturing, the method comprising:
providing a bulk of metal-based particles;
identifying, among the bulk, spherical metal-based particles having at least one of:
   g) an average aspect ratio greater than or equal to 0.95;
   h) an average roundness greater than or equal to 0.95; and
   i) an average Krumbein sphericity greater than or equal to 0.95; and
mechanically separating the spherical metal-based particles to form the metal-based powder comprising less than 1,000,000 of the metal-based particles per gram of the metal-based particles with a diameter between]10,15] μm, less than 2,000,000 of the metal-based particles per gram of the metal-based particles with a diameter between [5,10] μm, and less than 5,000,000 of the metal-based particles per gram of the metal-based particles with a diameter smaller than 5 μm.

In some implementations of the methods, the identification is performed by Scanning Electron Microscopy.

In another aspect, there is provided a consolidated part produced via additive manufacturing of the AM powder or powder composition as defined herein.

In another aspect, there is provided a process for manufacturing a part comprising:
providing a metal-based powder as defined herein, and
manufacturing the part from the metal-based powder using at least one of powder bed fusion, directed energy deposition, binder jetting, cold spray, metal injection molding, hot isostatic pressing and sintering.

In another aspect, there is provided a process for manufacturing a part from a metal-based powder, the process comprising:
preparing the metal-based powder according to the method as defined herein, and
manufacturing the part from the metal-based powder using at least one of powder bed fusion, directed energy deposition, binder jetting, and cold spray.

In another aspect, there is provided a powder composition for use in additive manufacturing, the composition consisting of:
metal-based particles wherein less than 8,000,000 of the metal-based particles per gram of the metal-based particles have a diameter smaller than or equal to 15 μm; and the metal-based particles have at least one of:
   j) an average aspect ratio greater than or equal to 0.95;
   k) an average roundness greater than or equal to 0.95; and
   l) an average Krumbein sphericity greater than or equal to 0.95; and
a remainder of the composition representing at most 10 wt % of a total weight of the composition.

In some implementations of the powder composition, the remainder is at least one of a ceramic, a lubricant and a binder.

The present document refers to a number of documents, the contents of which are hereby incorporated by reference in their entirety.

While the present metal-based powder and related methods, processes, or manufactured part will be described in conjunction with example embodiments, it will be understood that it is not intended to limit their scope to such embodiments. On the contrary, it is intended to cover all alternatives, modifications and equivalents as may be included as defined by the present description. The objects, advantages and other features of the present techniques will become more apparent and be better understood upon reading of the following non-restrictive description, given with reference to the accompanying drawings.

### BRIEF DESCRIPTION OF THE DRAWINGS

Implementations of metal-based powder and related methods, processes, or manufactured part which are suitable for additive manufacturing techniques are represented in and will be further understood in connection with the following figures.

FIGS. 1a to 1f are micrographs of the powders tested in the examples: FIG. 1a: powder A, FIG. 1b: powder B, FIG. 1c: powder C, and corresponding high magnification FIG. 1d: high magnification of powder A, FIG. 1e: high magnification of powder B, FIG. 1f: high magnification of small particles of powder C; wherein the red square at the top right corner in FIG. 1f corresponds to the high magnification image of large particles encountered on FIG. 1c.

FIG. 2 is a graphical representation of the cumulative logarithmic particle size versus the standard deviation of powders A, B, and C.

FIGS. 3a to 3c include 2D and 3D reconstructed images of powder A (FIG. 3a), powder B (FIG. 3b), and powder C (FIG. 3c) used to determine the spread density.

FIG. 4 is a graph showing the particle segregation in a powder bed as a function of powder location wherein a top section represents the powder collected from a position close to the beginning of the powder spreading and a bottom section represents powder collected at the end of powder spreading.

FIGS. 5a to 5d are DVS isotherms for powder A (FIG. 5a), powder B (FIG. 5b), and powder C (FIG. 5c), and sieved powder C (FIG. 5d).

FIG. 6 is a graph showing Carney flow variations of powders A, B, and C after oven drying.

FIGS. 7a to 7c are graphs showing a surface energy of powder A (FIG. 7a), powder B (FIG. 7b), and powder C (FIG. 7c).

FIG. 8 is a graph showing the work of cohesion of each of powders A, B, and C.

FIGS. 9a and 9b are graphs showing a dynamic angle of repose (FIG. 9a) and a cohesive index (FIG. 9b) determined for powders A, B, and C.

FIG. 10 is a graph showing density (in %) of the sintered part from powder A versus a temperature of the sintering (in ° C.).

### DETAILED DESCRIPTION

It is worth mentioning that throughout the following description when the article “a” is used to introduce an element it does not have the meaning of “only one” it rather means of “one or more”. It is to be understood that where the specification states that a component, feature, or characteristic “may”, “might”, “can” or “could” be included, that particular component, feature or characteristic is not required to be included.

In the following description, to provide a more concise description, some of the quantitative expressions given herein may be qualified with the term “about”. It is understood that, whether the term “about” is used explicitly or not, every quantity given herein is meant to refer to an actual given value, and it is also meant to refer to the approximation to such given value that would reasonably be inferred based on the ordinary skill in the art, including approximations due to the experimental, measurement conditions for such given value, and/or limitations of the measurement system. It is commonly accepted that a 10% precision measure is acceptable and encompasses the term “about”.

In the present description, an embodiment is an example or implementation of the inventions. The various appearances of “one embodiment,” “an embodiment” or “some embodiments” or “some implementations” do not necessarily all refer to the same embodiments. Although various features may be described in the context of a single embodiment, the features may also be provided separately or in any suitable combination. Conversely, although the present techniques may be described herein in the context of separate embodiments for clarity, the invention may also be implemented in a single embodiment.

As used herein, the expression “additive manufacturing process” or “AM process” refers to processes such as powder bed fusion (PBF or LPBF for laser powder bed fusion), directed energy deposition, binder jetting and cold spray. In this context, it also encompasses powder metallurgy processes such as metal injection molding, hot isostatic pressing and sintering.

As used herein, the term “powder” refers to a solid particulate material having a particle mass-median-diameter (MMD or d50) in the range of about 15 μm to about 150 μm, optionally between 15 μm and 68 μm, further optionally between 20 μm and 68 μm and further optionally between 45 μm and 68 μm.

As used herein the term “metal-based particle” means a particle containing a metal or metal alloy. In some embodiments, the metal-based particle consists of one or more metals and/or metal alloys. In some embodiments, the metal-based particle comprises, comprises a majority of, or consists essentially of one or more metals and/or metal alloys, along with one or more other components including, but not limited to non-metals and/or metalloids.

As used herein the expression “metal-based powder” means a powder containing a metal or metal alloy and the expression “AM powder” refers to the metal-based powder when used as feedstock for an additive manufacturing process. In some embodiments, the metal-based powder consists of metal-based particles. In some embodiments, the metal-based powder comprises, comprises a majority of, or consists essentially of metal-based particles along with one or more other components including, but not limited to ceramics, lubricants, binders and/or other additives.

In one aspect, there is provided a metal-based AM powder including metal-based particles being characterized by a specific combination of physicochemical properties, that provides enhanced performance to the AM powder when used in AM processes, and provides enhanced mechanical properties to AM consolidated parts which are produced from the AM powder according to the AM processes. It should be noted that the term “enhanced” refers to an improvement in comparison to the performance in additive manufacturing of a powder or of a consolidated part, when using metal-based particles which do not meet at least one of the physicochemical properties which are described herein.

In some embodiments, the metal-based particles can be aluminum-based particles comprising aluminum or an aluminum alloy such as, and without being limitative, AlSi7Mg, AlMgSc, AlCu, AlSi10Mg, A357, Scalmalloy® Al and CP Al. It should be noted that “CP Al” is an expression referring to unalloyed commercial purity aluminum, and that CP Al is available in high purity variants of 99.9%, 99.99% and 99.999% purity respectively which are all included in the expression CP Al. However, it can be appreciated that other metals can be used, such as, and without being limitative, Zn, Cu, Fe, Li, Ti, Ni, Au, Pd or Ag, and other metal alloys, such as, and without being limitative, steel or other iron alloys, SnPb, NdFeB, ZnPd, titanium-based alloys, CoCr, brass-based alloys and copper-based alloys. It is also possible that the art can be expanded to include ceramic and metal composite materials also being produced for the purpose of AM.

More particularly, there is provided an AM powder including metal-based particles having a particle size distribution (PSD) and a sphericity that are tailored to exhibit low moisture sorption, thereby enabling passivation of an outer surface of the metal-based particles with a thin oxide layer.

A thin oxide layer is to be understood herein as any oxide layer derived from passivation of the metal from the metal-based particles and having a thickness of at most about 5 nm. The thickness of the oxide layer is considered to be independent of the particle diameter.

### Moisture Sorption

Moisture sorption characteristic of powders influence the powder flowability, which is an important parameter to be controlled in AM processes. AM powders including metal-based particles having a thin outer metal oxide layer typically have improved flowability because of the reduced agglomeration of the particles, which in turn can result in improved AM process predictability. However, AM powders including metal-based particles having this thin outer metal oxide layer also typically have high surface moisture sorption, thereby leading to an unstable composition during storage, handling and building (including re-use), and to significant variations in oxygen and moisture content. Exposure of such AM powders to oxygen and humidity are known to provide reaction products that can degrade the microstructure (e.g. resulting in increased porosity), and ultimately adversely affect the mechanical properties (e.g. mainly ductility and toughness) of the resulting parts.

Furthermore, AM powders having a higher content of fine metal-based particles tend to exhibit higher moisture sorption than powders having a lower content of fine metal-based particles, due to the high surface area of the fine particles. As used herein, the term “fines” or the expression “fine [ . . . ] particles” refer to particles smaller than about 15 μm and typically larger than about 1 μm in diameter.

In contrast, low moisture adsorption is typically achieved with metal-based particles being passivated with a thick outer oxide layer. As the thick oxide layer at the surface of the metal-based particles tend to limit moisture sorption, the shelf life of the powder is improved. However, presence of a thicker outer oxide layer can lead to poorer mechanical properties in the resulting parts of the AM process.

Therefore, reaching the right balance in terms of thickness of the oxide layer and moisture sorption of an AM powder to provide adequate mechanical properties to a resulting AM part, made using such AM powder, is a challenging task.

The presently described AM powder includes metal-based particles having a specific combination of physicochemical properties enabling exhibition of a low degree of moisture sorption, while maintaining a thin outer oxide layer. In some embodiments, the AM powder has an average degree of moisture sorption less than about 0.006 wt %. It has been found that powders comprising metal-based particles characterized by a specific PSD and sphericity show low moisture sorption, regardless of the thickness of the oxide layer, thereby leading to good flowability, low particle agglomeration, enhanced packing density, which results in improved mechanical properties of a manufactured AM consolidated part.

In some embodiments, a majority of or essentially all of the metal-based particles of the AM powder are characterized by a thin outer metal oxide layer. In some embodiments, a thin outer metal oxide layer can be interpreted as the average thickness of the outer metal oxide layer being less than about 5 nm, this value being independent of particle diameter (defined above in the range of about 15 μm to about 150 μm).

### Particle Size Distribution Implementations

The AM powder can refer herein to a metal-based AM powder which can consist of the metal-based particles, or consist essentially of the metal-based particles, such that the metal-based particles as defined herein accounts for at least 95 wt %, at least 96 wt %, at least 97%, at least 98%, at least 99% or 100% of a total weight of the metal-based AM powder. However, one skilled in the art will readily understand that, depending on the selected additive manufacturing process, one or more other components including, but not limited to ceramics, lubricants, binders and/or other additives can be added to the metal-based particles. In that case, the AM powder would comprise the metal-based particles and required additional components. For example, certain AM processes can require addition of up to 10 wt % of ceramic particles with respect to a total weight of the AM powder.

Known processes produce particles having a diameter of less than 15 μm which qualifies as fines. These fines both attach to larger particles from the powder (see Surface properties implementations) or exist as discrete individual particles.

PSD is readily known as a relative amount of particles present according to size in the bulk of particles. PSD is herein expressed as a number of metal-based particles per gram of AM powder having a specific diameter, considering that the AM powder at least consists essentially of the metal-based particles.

By adjusting the PSD of the metal-based particles in the AM powder, fines content can be minimized and even removed, to further control the moisture sorption capacity of the AM powder. There is provided a metal-based AM powder having a fines content which is minimized to reduce the moisture sorption capacity of the metal-based powder.

In some implementations, the metal-based AM powder has a low content of fines, which more specifically means that less than about 20,000,000 metal-based particles per gram of the metal-based particles having a diameter smaller than or equal to 15 μm. In some implementations, the metal-based AM powder is considered as being “substantially fines-free”. More specifically, the metal-based particles of the AM powder can include less than about 8,000,000 metal-based particles per gram of the metal-based particles having a diameter smaller than or equal to about 15 μm. By including less than about 8,000,000 metal-based particles per gram of the metal-based particles having a diameter smaller than or equal to about 15 μm, the AM powder can be considered as being “substantially fines-free”. As mentioned above, fine particles are defined as having a diameter smaller than about 15 μm and greater than about 1 μm, the latter corresponding to the resolution limit of the measurement device used.

The PSD of the metal-based particles of the AM powder can also be characterized by the diameter of a specified weight percentage of the metal-based particles in a volume of powder being within a defined range of the mass-median-diameter (d50). In some embodiments, about 70 wt % or about 75 wt % of the metal-based particles in the AM powder are within about 5 μm of the mass-median-diameter (d50). In some embodiments, 99.6 wt % of the metal-based particles in the AM powder are within about 15 μm or about 20 μm of the mass-median-diameter (d50). In some embodiments, 99.6 wt % of the metal-based particles in the AM powder are within about 10 μm of the mass-median-diameter (d50).

The dimensionless PSD width (S_{w}) is a parameter representing the width of the particle size distribution (PSD). To calculate the S_{w} value, a log-normal slope parameter method is used. More particularly, the standard deviations of the cumulative distribution are plotted against the logarithmic particle size resulting in a linear plot where the slope represents the S_{w}, while the intersection with the x-axis is equivalent to the mass-median-diameter, d50. If the particle size range is very narrow, high values of S_{w} are expected. Powders from different sources can thus be compared with the S_{w} and the mass-median-diameter value of the PSD on a single plot. A powder having a large fines content will generally have a wider PSD and a lower S_{w}.

In some embodiments, the AM powder includes metal-based particles with a narrow PSD. More specifically, the metal-based particles of the AM powder are characterized by a dimensionless particle size distribution width (Sw) greater than about 10. In other embodiments, the metal-based particles of the AM powder are characterized by a dimensionless particle size distribution width (S_{w}) greater than about 7.5. In some embodiments, the metal-based particles of the AM powderare characterized by a dimensionless particle size distribution width (S_{w}) greater than about 5.

### Spherical Morphology Implementations

In addition to the AM powder being substantially fines-free, the metal-based particles of the AM powder have a spherical morphology defined by a specific sphericity as defined below.

The sphericity of a particle influences erosion, transportation, and deposition patterns of such particle. The sphericity can be defined as composed of the relative length of the particle along the three orthogonal axes X, Y, and Z and the roundness of the particle corners and edges. As used herein, the sphericity of the metal-based particles can be defined by the average value of the aspect ratio, the Krumbein sphericity, the roundness (circularity of projection), the Wadell roundness, any characterization using symmetry and convexity, or any other characterization which could be reasonably inferred by one skilled in the art from the definitions provided herein.

For example, circularity of projection may be calculated according to the ratio of projected area to perimeter squared which is defined by the following formula:

$$4 \times π \times \frac{A}{{l}^{2}}$$

where “A” is the projected area and “I” is the perimeter of the particle.

The metal-based particles included in the AM powder are particles which can be qualified as highly spherical particles, i.e. their sphericity being characterized by an aspect ratio average greater than or equal to about 0.95; and/or a roundness average greater than or equal to 0.95; and/or a Krumbein sphericity average greater than or equal to 0.95; and/or a Wadell roundness average greater than or equal to 0.95.

In some embodiments, the metal-based particles in the AM powder have an average aspect ratio greater than or equal to about 0.95. In some embodiments, the metal-based particles in the AM powder have an average aspect ratio greater than or equal to about 0.971. In some embodiments, the metal-based particles in the AM powder have an average aspect ratio greater than or equal to about 0.985. In some embodiments, the metal-based particles in the AM powder have an average roundness greater than or equal to 0.95. In some embodiments, the metal-based particles in the AM powder have an average roundness greater than or equal to 0.964. In some embodiments, the metal-based particles in the AM powder have an average roundness greater than or equal to 0.9995. In some embodiments, the metal-based particles in the AM powder have an average Krumbein sphericity greater than or equal to 0.95. In some embodiments, the metal-based particles in the AM powder have an average Krumbein sphericity greater than or equal to 0.9995. In some embodiments, the metal-based particles in the AM powder have an average Wadell roundness greater than or equal to 0.95. In some embodiments, the metal-based particles in the AM powder have an average Wadell roundness greater than or equal to 0.991. In some embodiments, the metal-based particles in the AM powder have an average Wadell roundness greater than or equal to 0.995.

In some implementations, the metal-based particles can be characterized by at least one of the following sphericity related characteristics:
Circularity of projection CoP50 between 0.90 and 1.00
Circularity of projection CoP90/CoP10 between 1.00 and 1.50
Aspect Ratio AR50 between 0.95 and 1.00
Aspect Ratio AR90/AR10 between 1.00 and 1.50
Wt % of particles with circularity of projection inferior to 0.90 between 0.0 wt % and 40.0 wt %
Wt % of particles with Aspect Ratio inferior to 0.90 between 0.0 wt % and 40.0 wt %
Circularity of projection mean between 0.90 and 1.00
Symmetry mean between 0.90 and 1.00
Aspect Ratio mean between 0.90 and 1.00
Roundness mean between 0.90 and 1.00

### Surface Properties Implementations

In some embodiments, a majority of or essentially all of the metal-based particles of the AM powder are also characterized by a low surface roughness and amount of satellites, i.e. small particles adhering to the surface of regular sized particles that form during the preparation of the powder, for example, during an atomization process. It should be noted that the term “smooth” or “smoothness” can be interpreted herein as having low surface roughness which is derived at least from the high sphericity as previously represented, absence of surface attached fines and a surface largely devoid of crevices. Smoothness can be characterized herein by the specific surface area as exemplified in the experimentation section.

In some implementations, the metal-based particles have a specific surface area of at most about 0.15 m²/g when measured using Inverse Gas Chromatography. Optionally, the specific surface area is at most about 0.05 m²/g or at most about 0.025 m²/g.

In some embodiments, the metal-based particles have a thin oxide layer, i.e. an oxide layer having a thickness of at most about 5 nm. To control and maintain the thickness of the oxide layer, i.e. passivation layer, the particles can be manufactured for example by gas atomization or plasma atomization under an inert gas environment and controlled thermal conditions. The resulting powder can be packed and sealed under inert gas without exposure to air. In addition to thickness, the oxide layer of the metal-based particles can be characterized as being uniform, i.e. the standard deviation of oxides layer thickness across the powder is such that the thickness can be considered as advantageously uniform. Low surface roughness of the present metal-based particles also allows for uniform levels of surface oxides.

It should be understood that the metal-based particles defined herein are not limited to being characterized by an oxide layer thickness of at most 5 nm. Indeed, even if a thin oxide layer provides certain advantages with respect to properties of the powder and resulting part, one skilled in the art will understand that additional oxides can be added for example for the purpose of meeting customized requirements for specific levels of surface oxides. Such additional oxide layer thickness can be created by exposing the metal-based particles to additional oxygen for a controlled time, under a controlled exposure level.

### Synergistic Effect

It has been shown that the combination of specific physicochemical properties can exhibit a synergistic response for enhancing the AM powder performance and the mechanical properties of a consolidated AM part with respect to conventional powders which do not present the combination of properties described herein, e.g by decreasing moisture sorption of the metal-based particles, enhancing chemical stability of the powder, enhancing flowability of the powder, and enhancing spread density of the powder.

It should be understood that the terms “synergy” or “synergistic”, as used herein, refer to the interaction of two or more physicochemical properties of the metal-based particles so that their combined effect is greater than the sum of their individual effects, this may include, in the context of the present description, the action of two or more of the PSD (fines content and width of the distribution), sphericity, oxide layer thickness, surface roughness, and surface satellites amount.

In some scenarios, the substantial absence of fines in the AM powder and the high sphericity of the metal-based particles can be present in synergistically effective interaction. A combination of high sphericity as previously represented, a surface area close to that of a perfect sphere, an absence of attached fines and a surface largely devoid of crevices and surface roughness results in a synergistic effect termed smoothness. In some scenarios, the substantial absence of fines in the AM powder, the high sphericity and the smoothness of the metal-based particles can be present in synergistically effective interaction. In some scenarios, the substantial absence of fines in the AM powder, the smoothness and the high sphericity of the metal-based particles can be present in synergistically effective interaction to reduce moisture adsorption by 50% and allow the particles to be dried two times faster. In some scenarios, the narrow particle size distribution and the high sphericity of the metal-based particles, the substantial absence of fines in the AM powder, and the smoothness of the metal-based particles can be present in synergistically effective interaction to enhance spread density of the AM powder by packing a powder bed 30% more densely. In some scenarios, the high sphericity and the smoothness of the metal-based particles, and the substantial absence of fines in the AM powder can be present in synergistically effective interaction to enhance flowability of the powder which flows 2.5 times faster than conventional powders, and reduce particle agglomeration.

For example, the approach as set out in S. R. Colby, “Calculating synergistic and antagonistic responses of herbicide combinations”, Weeds 15, 20-22 (1967), can be used to evaluate synergy. Expected efficacy, E, may be expressed as: E=X+Y(100−X)/100, where X is the efficacy, expressed in % of the performance under study, of a first physicochemical parameter of a combination, and Y is the efficacy, expressed in % of the performance under study, of a second physicochemical parameter of the combination. The two physicochemical parameters are said to be present in synergistically effective amounts when the observed efficacy is higher than the expected efficacy.

For example, as shown in the experimentation section, the combination of parameters such as the substantial absence of fines and high sphericity of the particles, yield a synergistic effect in that the AM powder exhibits lower moisture sorption, regardless of the thickness of the oxide layer of the particles, thereby enhancing the flowability and packing density of the resulting AM powder.

In some embodiments, the AM powder comprises, comprises a majority of, or consists essentially of, or consists of the metal-based particles with the AM powder containing less than about 8,000,000 metal-based particles per gram of AM powder having a diameter smaller than or equal to about 15 μm. In some embodiments, the metal-based particles in the AM powder have an average aspect ratio greater than or equal to about 0.95. In some embodiments, the metal-based particles in the AM powder have an average aspect ratio greater than or equal to about 0.971. In some embodiments, the metal-based particles in the AM powder have an average aspect ratio greater than or equal to about 0.985. In some embodiments, the metal-based particles in the AM powder have an average roundness greater than or equal to 0.95. In some embodiments, the metal-based particles in the AM powder have an average roundness greater than or equal to 0.964. In some embodiments, the metal-based particles in the AM powder have an average roundness greater than or equal to 0.9995. In some embodiments, the metal-based particles in the AM powder have an average Krumbein sphericity greater than or equal to 0.95. In some embodiments, the metal-based particles in the AM powder have an average Krumbein sphericity greater than or equal to 0.9995. In some embodiments, the metal-based particles in the AM powder have an average Wadell roundness greater than or equal to 0.95. In some embodiments, the metal-based particles in the AM powder have an average Wadell roundness greater than or equal to 0.991. In some embodiments, the metal-based particles in the AM powder have an average Wadell roundness greater than or equal to 0.995.

In other implementations, the AM powder comprises, comprises a majority of, or consists essentially of, or consists of the metal-based particles with the AM powder containing less than about 1,000,000 particles per gram of the AM powder have a diameter between about]10,15] μm, less than about 2,000,000 particles per gram of the metal-based particles have a diameter between about [5,10] μm, and less than about 5,000,000 particles per gram of the metal-based particles have a diameter smaller than about 5 μm. In some embodiments, the metal-based particles in the AM powder have an average aspect ratio greater than or equal to about 0.95. In some embodiments, the metal-based particles in the AM powder have an average aspect ratio greater than or equal to about 0.971. In some embodiments, the metal-based particles in the AM powder have an average aspect ratio greater than or equal to about 0.985. In some embodiments, the metal-based particles in the AM powder have an average roundness greater than or equal to 0.95. In some embodiments, the metal-based particles in the AM powder have an average roundness greater than or equal to 0.964. In some embodiments, the metal-based particles in the AM powder have an average roundness greater than or equal to 0.9995. In some embodiments, the metal-based particles in the AM powder have an average Krumbein sphericity greater than or equal to 0.95. In some embodiments, the metal-based particles in the AM powder have an average Krumbein sphericity greater than or equal to 0.9995. In some embodiments, the metal-based particles in the AM powder have an average Wadell roundness greater than or equal to 0.95. In some embodiments, the metal-based particles in the AM powder have an average Wadell roundness greater than or equal to 0.991. In some embodiments, the metal-based particles in the AM powder have an average Wadell roundness greater than or equal to 0.995.

In other implementations, the AM powder comprises, comprises a majority of, or consists essentially of, or consists of the metal-based particles with the AM powder including less than about 500,000 metal-based particles per gram of the metal-based particles having a diameter between about]10,15] μm, less than about 1,000,000 metal-based particles per gram of the metal-based particleshaving a diameter between about [5,10] μm, and less than about 3,000,000 metal-based particles per gram of the metal-based particles having a diameter smaller than about 5 μm. In another embodiment, less than about 300,000 metal-based particles per gram of the metal-based particles have a diameter between about]10,15] μm, less than about 700,000 metal-based particles per gram of the metal-based particles have a diameter between about [5,10] μm, and less than about 2,500,000 metal-based particles per gram of the metal-based particles have a diameter smaller than about 5 μm. In some embodiments, the metal-based particles in the AM powder have an average aspect ratio greater than or equal to about 0.95. In some embodiments, the metal-based particles in the AM powder have an average aspect ratio greater than or equal to about 0.971. In some embodiments, the metal-based particles in the AM powder have an average aspect ratio greater than or equal to about 0.985. In some embodiments, the metal-based particles in the AM powder have an average roundness greater than or equal to 0.95. In some embodiments, the metal-based particles in the AM powder have an average roundness greater than or equal to 0.964. In some embodiments, the metal-based particles in the AM powder have an average roundness greater than or equal to 0.9995. In some embodiments, the metal-based particles in the AM powder have an average Krumbein sphericity greater than or equal to 0.95. In some embodiments, the metal-based particles in the AM powder have an average Krumbein sphericity greater than or equal to 0.9995. In some embodiments, the metal-based particles in the AM powder have an average Wadell roundness greater than or equal to 0.95. In some embodiments, the metal-based particles in the AM powder have an average Wadell roundness greater than or equal to 0.991. In some embodiments, the metal-based particles in the AM powder have an average Wadell roundness greater than or equal to 0.995.

In some embodiments, the AM powder comprises, comprises a majority of, or consists essentially of, or consists of highly spherical metal-based particles characterized by an average Krumbein sphericity greater than 0.999 and a narrow size distribution, with about 80 wt % of the particles in the AM powder being within about 5 μm of the mass-median-diameter (d50). In some embodiments of the above-described AM powders, the AM powder is further characterized by an average apparent density greater than or equal to about 53%. In some embodiments, the AM powder is further characterized by an average apparent density greater than or equal to about 55%. In some embodiments, the AM powder is further characterized by an average apparent density greater than or equal to about 56%.

### Method and Process Implementations

One skilled in the art will appreciate that various methods can be used to obtain metal-based AM powders having specific parameters and properties as described herein. As mentioned above, metal-based particles can be manufactured using a gas atomization approach within an inert gas environment to ensure that the particles have a minimal or thin outer oxide layer. More specifically, to control and maintain the thickness of the oxide layer, i.e. passivation layer, the particles can be manufactured for example by gas atomization or plasma atomization under an inert gas environment and the resulting powder can be packed and sealed under inert gas without exposure to air. The type of apparatus and the operating conditions of the process can be selected and adjusted to produce metal-based particles meeting the specific physicochemical parameters. For example, the thickness of the oxide layer forming on an outer surface of the metal-based particles can be controlled using controlled passivation techniques, where such particles are exposed to oxygen under controlled conditions.

Should the manufacturing process produce metal-based particles slightly offset from the target in terms of specific parameters and properties, particles with the desired PSD, surface properties and sphericity can then be identified and located using a Scanning Electron Microscope (SEM) and mechanically separated from the remainder of the particles, so as to be further used as constituents of the AM powder. In other implementations, AM powder with the desired PSD, can be obtained by various screening, sieving or classification processes, such as vibration sieving, air classification or other suitable techniques to select suitable metal-based particles for the AM powder. Metal-based particles having the desired sphericity and/or surface properties can be separated from other particles using, for example, various sorting techniques such as vibration sorting and friction-based sorting.

### Part Production by Additive Manufacturing

As readily known by one skilled in the art, physicochemical characteristics of the metal-based particles included in the AM powder have an impact on the behavior the AM powder when used as feedstock for the AM process, thereby having an impact on the efficiency of the AM process as well as on the mechanical properties of the consolidated parts made using the AM powder according to the AM process.

For example, the combination of at least the absence of fines in the powder, high sphericity and minimized surface roughness of the metal-base particles included in the AM powder, provides enhanced flowability, spread density and reduced particle agglomeration to the AM powder when used in an AM process, and provides at least enhanced tensile strength, ductility, toughness, hardness, yield strength, fatigue life, and isotropy to an AM consolidated part made according to the AM process. Advantageously, mechanical properties derived from the use of the present metal-based particles to consolidate a part are predictable and reproducible, as exemplified in the experimentation section with respect to tensile strength.

In some embodiments, the performance of the AM powder can be characterized by a high flowability, and more specifically by a Hall flow lower than or equal to about 40 seconds per 50 grams. In other embodiments, the AM powder is characterized by a Hall flow lower than or equal to about 32 seconds per 50 grams. Alternatively, in some embodiments, the AM powder is characterized by a Carney flow lower than or equal to about 7 seconds per 50 grams, and optionally lower than or equal to about 6 seconds per 50 grams.

In some embodiments, the AM powder is characterized by a ratio of an average spread density to the average apparent density greater than about 85%. In some embodiments, the AM powder is characterized by a ratio of an average spread density to the average apparent density greater than about 90%. In some embodiments, the AM powder is characterized by a ratio of the average spread density to the average apparent density greater than 95%. In other embodiments, the AM powder is characterized by a ratio of the average spread density to the average apparent density greater than 97.5%. In some embodiments, the AM powder is characterized by a ratio of an average spread density to the average apparent density greater than about 99%.

These performance properties can be suitable for use as a feedstock to an AM process to manufacture a consolidated part. For example, the AM powders described above (e.g. being substantially fines-free, having a highly spherical morphology and optionally a narrow particle size distribution), also lead to, during powder spreading on the build platform, a homogeneous powder bed with high packing density, i.e. spread density. Powder characteristics such as narrow particle size distribution, high sphericity, and smoothness improve powder spreadability allowing a homogeneous powder bed. In contrast, the presence of a large amount of fines and irregular particles negatively impacts the powder spreadability, giving rise to lower spread densities.

The AM powder described above (e.g. being substantially fines-free, having a highly spherical morphology and optionally a narrow particle size distribution), also lead to good efficiency in cold spray processes and improved quality of the resulting parts. More precisely, fines-free powders enable the temperature and pressure of the cold spray gun to be increased without clogging the gun, which improves coating and deposition efficiency. The combination of the fines-free and spherical parameters improves flowability and the uniformity of the spray. This can allow the use of relatively large particles. In some embodiments, the AM powder is characterized by a mass-median-diameter (d50) between about 45 μm to about 90 μm, thereby enabling high deposition rates of about 15 g/min to about 30 g/min in cold spray applications. In other embodiments, the AM powder is characterized by a particle mass-median-diameter (d50) of about 125 μm.

In AM powder bed systems, which may use a variety of powders of non uniform shape and thicker oxide layers, there is a significant advantage to the synergistic effects of the metal-based particles characterized herein as having, for example, a combination of low oxygen content, highly spherical morphology, narrow particle size distribution and being substantially fines-free.

In another example, the AM powder described herein (e.g. having a low oxygen content, having a narrow particle size distribution, being substantially fines-free and having a smooth, highly spherical morphology) enables zero-compaction sintering of reactive metals such as aluminum alloys because the combination of physicochemical properties described herein improves densification, which would normally be reliant on large surface area provided by fine particles and/or reliant on the use of sintering aid and compaction. Indeed, sintering of conventional powders generally occurs when a sintering aid is used and when subsequent compaction of the powder is performed. It has been shown that sintering was enabled without the use of any sintering aid or subsequent compaction step and still allowed improved densification with respect to conventional metal-based powders.

In other implementations, there is provided a consolidated part (referred to as an AM part) produced by additive manufacturing from the AM powder described herein. Parts including statically loaded parts such as hinges and brackets, or dynamically loaded parts undergoing stress cycles would specifically benefit from enhanced properties deriving from the use of the metal-based particles described herein as AM powder. The resulting AM part is characterized by enhanced mechanical properties in comparison to another AM part which would be made from an AM powder including particles which do not meet the specific combination of properties that are described herein, namely at least the combined PSD, sphericity and/or smoothness described herein.

### EXPERIMENTAL RESULTS

### Characterization Methods

To characterize the morphology of the powders, scanning electron microscopy (SEM) can be carried out using a microscope. For instance, in the example detailed below, a Hitachi SU3500 Scanning Electron Microscope was used. In addition, a Retsch CAMSIZER X2 using Dynamic Image Analysis was used for the particle shape measurements.

The apparent density can be assessed using the Hall and Carney funnels, as well as the Arnold meter according to the ASTM standards B212, B417, and B703, respectively [ASTM B212-17, Standard Test Method for Apparent Density of Free-Flowing Metal Powders Using the Hall Flowmeter Funnel, ASTM International, West Conshohocken, Pa., 2017; ASTM B417-13, Standard Test Method for Apparent Density of Non-Free-Flowing Metal Powders Using the Carney Funnel, ASTM International, West Conshohocken, Pa., 2013; ASTM B703-10, Standard Test Method for Apparent Density of Metal Powders and Related Compounds Using the Arnold Meter, ASTM International, West Conshohocken, Pa., 2010].

Powder flowability can be measured using Hall and Carney funnels according to the ASTM standards [B213-17, Standard Test Methods for Flow Rate of Metal Powders Using the Hall Flowmeter Funnel, ASTM International, West Conshohocken, Pa., 2017; ASTM B964-16, Standard Test Methods for Flow Rate of Metal Powders Using the Carney Funnel, ASTM International, West Conshohocken, Pa., 2016].

The moisture sorption behavior of powders can be evaluated using the gravimetric Dynamic Vapor Sorption (DVS) technique by a DVS Intrinsic apparatus measuring mass changes (±0.1 μg) under controlled temperature and humidity. In the examples detailed below, prior to testing, samples were individually dried under vacuum at 200° C. Dried powder samples (˜100 mg) were loaded onto an aluminum pan and placed into a chamber kept at 25° C., and allowed to reach equilibrium, i.e., until the change in mass as a function of time is less than 0.002% per minute. Testing starts by reaching 0% relative humidity (RH) and soaking for 12 hours. Then, the RH was increased in steps of 10% until 80% RH was reached. Each RH step was held until equilibrium. Once 80% RH was reached, the RH was ramped down to 0% in steps of 10 as per the ramp up.

In the examples detailed below, to evaluate the effect of humidity on the flowability of the tested powders, a multiple cycle flowability test using the Carney funnel was performed. The test consisted of drying 50 g of each powder at 200° C. under vacuum for a period of 2 hours. Immediately after drying, Carney flow tests were carried out continuously using the same powder at a RH of 40% until a total of 30 measurements were obtained.

PSD can be measured with a laser particle size analyzer. In the examples detailed below, the PSD was measured using a Horiba laser particle size analyzer (Model LA-920).

Powder spread density can be studied using a single layer of powder of 100 μm thick, which is CT scanned. In the examples below, CT scanning is performed with a Zeiss Xradia 520 Versa 3D X-ray microscope. After scanning, the acquired micro-computed tomography images are segmented using the open source image-processing platform image [Schindelin, J. et al., Fiji: an open-source platform for biological-image analysis, Nature methods, 9 (2012) 676-682] and 3D reconstructed by the Dragonfly software from Object Research Systems (ORS) [Dragonfly 3.1 [Computer software]. Object Research Systems (ORS) Inc, Montreal, Canada, 2016; software available at http://www.theobjects.com/dragonfly.]. Finally, the powder internal porosity as well as the spread density are obtained from the total volume in percentage occupied by the internal porosity and particles within the scanned area, respectively. As can be appreciated from the above regarding the powder spreadability factors, the fines-free powder of the invention having highly spherical particles has a good packing behavior that is consistent with the apparent density.

In the examples below, the particle segregation was studied within a single layer 50 μm thick. The surface of a built plate was patterned by rastering the laser of a Renishaw AM400 to simulate the surface roughness created in a part during printing. The powder was then spread over the plate using the Renishaw AM400 spreading system. Once the powder layer was deposited over the plate, representative samples were collected from the top and bottom sections for PSD analysis by SEM to confirm whether powder segregation was occurring.

In the examples below, the surface energy was measured to evaluate the work of cohesion, which gives an indication of the natural affinity of the powders for agglomeration. The surface energy, defined as the energy per unit area required to create a new interface and described by the sum of the dispersive component (London dispersion forces) and the specific component (dipole-dipole, induced dipole, and hydrogen bonding interactions), was determined using inverse gas chromatography (IGC) [Johnson, K. et al., Surface energy and the contact of elastic solids, in: Proceedings of the Royal Society of London A: Mathematical, Physical and Engineering Sciences, The Royal Society, 1971, pp. 301-313; Voelkel, A. et al., Inverse gas chromatography as a source of physiochemical data, J. Chromatogr. A, 1216 (2009) 1551-1566]. Details of the method can be found in reference [Mohammadi-Jam, S. et al., Inverse gas chromatography applications: A review, Adv. Colloid Interface Sci., 212 (2014) 21-44]. Pre-salinized glass columns (300 mm length, 4 mm inner diameter) were filled with different powders, and the ends were plugged with salinized glass wool. The columns were then placed in a surface energy analyzer (SEA), with helium flowing through at 10 ml/min as an inert carrier gas and methane was used for dead volume corrections. All measurements were carried out at 30° C. and 0% RH. In order to determine the specific surface area of the samples, octane was passed through each column at set molecular amounts, and an isotherm was produced. From this isotherm, the BET equations were used to determine the specific surface area. To determine the dispersive component of the surface energy, alkane probes with increasing chain length, from heptane to nonane (HPLC grade, Sigma Aldrich, USA), were passed through the sample at set (fractional) surface coverages, from 0.1 to 0.3. Sufficient time was allowed between injections to allow for the probe to pass completely through the column. For the specific component of the surface energy, dichloromethane and toluene (both HPLC grade, Sigma Aldrich, USA) were used as the polar probes.

In the examples below, two different measurements, static and dynamic angles of repose, were also used to assess the powder cohesiveness. The static angle of repose can be measured by freely flowing powders through a funnel to form a characteristic conical heap onto a plate. The angle developed between the surface of the conical heap and the plate represents the static angle of repose. For this purpose, 50 g of powders were dispensed through a Carney funnel onto the center of a plate. The static angle of repose was then measured between the surface of the powder heap and the plate. This procedure was repeated three times for each powder and the average values for the static angle of repose were reported.

The dynamic angle of repose was measured using a granular material flow analyzer, Granudrum®. A transparent drum was half-filled with powders and rotated at an angular velocity to induce powder flow. The rotating drum was backlit and a camera was used to capture images of the avalanche at different times. Angular velocities ranging from 2-20 rpm were used. For each angular velocity, 50 images of the drum separated by 1000 ms were acquired. The interface location between air and powder was automatically detected and the average position as well as the deviations around this average position were automatically computed for each velocity. The dynamic angle of repose was determined from the center of the flow, and the deviations from the interface were directly related to the cohesion inside the drum and denominated as cohesion index [Lumay, G. et al., Measuring the flowing properties of powders and grains, Powder Technol., 224 (2012) 19-27]. The process was repeated three times and the average values of the dynamic angle of repose are presented.

### Example—AlSi7Mg Powder Properties Comparison to Enhance Additive Manufacturing Processing

Three powders were used in the examples below. The three powders were named A, B and C, and are all based on the A356-A357 aluminum alloys.

### Powder Morphology and Particle Size Distribution

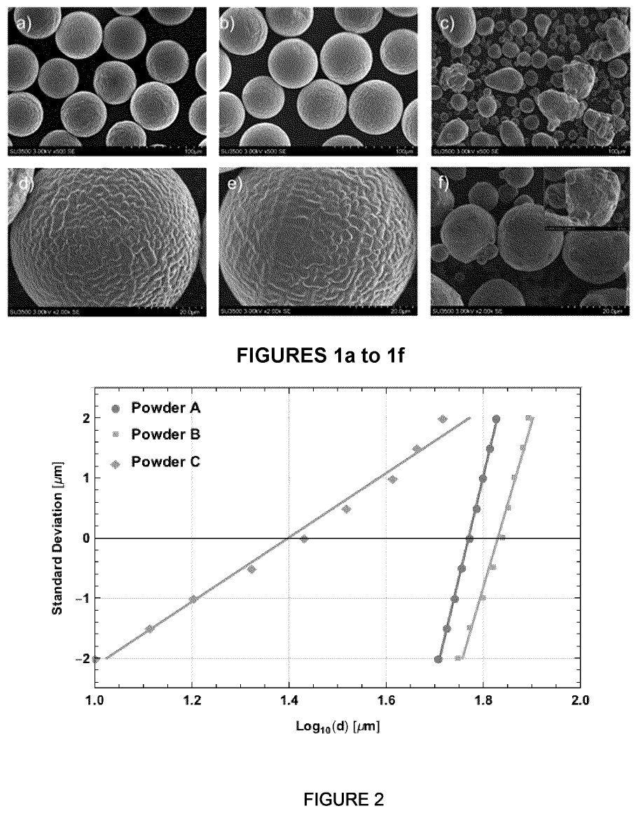

The powder morphology corresponding to powders A, B, C imaged by SEM is shown in FIGS. 1a to 1c. Spherical particles with nearly no irregular morphologies, smooth surfaces, and a limited amount of satellites were observed for powders A and B. In comparison, the particles present in powder C are generally spherical (but less so than powders A and B) and show irregular surfaces. As mentioned above, the sphericity of the particles can be expressed in terms of the average aspect ratio, the average Krumbein sphericity, average roundness (circularity of projection) and average Wadell roundness. Table 1 below presents the sphericity measurements of powders A, B and C. Powders A and B show a highly spherical morphology with an aspect ratio, a Krumbein sphericity, a roundness, and a Wadell roundness greater than 0.95 (average values).

TABLE 1
Sphericity measurements for powders A, B, and C

| | | Krumbein | | Wadell |
|---|---|---|---|---|
| Powder | Aspect ratio | sphericity | Roundness | roundness |
| Powder A | 0.9925 | 0.994 | 0.9785 | 0.995 |
| Powder B | 0.991 | 0.9945 | 0.9735 | 0.9945 |
| Powder C | 0.846 | 0.895 | 0.883 | 0.683 |

Additionally, a large amount of fines and irregular particle morphologies containing satellites are observed in powder C. The content of fines is characterized as an amount of particles per gram that are smaller than or equal to about 15 μm, 10 μm and 5 μm as presented in Table 2 below. The results indicate that powders A and B are substantially fines-free by including less than 8,000,000 particles per gram of the metal-based particles having a diameter smaller than or equal to about 15 μm. It is also shown that virtually no particle having a diameter smaller than 5 μm was detected in powders A and B.

TABLE 2
Content of fines per gram of the tested powders A, B,
and C (expressed in millions of particles per gram)

| Powder | ≤15 μm | ≤10 μm | ≤5 μm |
|---|---|---|---|
| Powder A | 0.159 | 0.130 | 0 |
| Powder B | 0.488 | 0.488 | 0 |
| Powder C | 120 | 75 | 26 |

In view of the below test results for powders A, B and C, it can be concluded that powders A and B have a combination of a highly spherical morphology and a low fines content. As presented below, this combination provides a synergistic effect in terms of enhanced powder flowability and reduced moisture sorption.

As mentioned above, the PSD expressed in terms of the log-normal slope parameter method helps to easily identify in a single plot the S_{w} and the median value of the PSD, which is useful when comparing different powders. A graphical representation of the cumulative particle size against the standard deviations used to determine the S_{w} of powders A, B, and C is depicted in FIG. 2. It is clearly seen that powder C presents the lower slope and the finer particles when it is compared with powders A and B. The corresponding PSD D₁₀, D₅₀, D₉₀, and the dimensionless S_{w} values are listed in Table 3. Powders A and B present a narrow PSD distribution with S_{w} values of 33.8 and 27.6 respectively, while powder C shows a S_{w} of 5.4 indicating a wide PSD.

TABLE 3
Particle size distribution of the tested powders A, B, and C.(μm)

| Powder | D₁₀ | D₅₀ | D₉₀ | S_{w} |
|---|---|---|---|---|
| Powder A | 53 | 59 | 66 | 33.8 |
| Powder B | 59 | 68 | 77 | 27.6 |
| Powder C | 12 | 25 | 51 | 5.4 |

The particle size distribution can also be expressed as the percentage of the particles in a volume of powder having a diameter within a defined range of the mass-median-diameter (d50). Table 4 below shows that a large majority of the particles, 79.8 wt % and 70.7 wt % respectively, of powders A and B are within 5 μm of the mass-median-diameter d50, while only 31.7 wt % of the particles of powder C are within 5 μm of d50.

TABLE 4
Weight % within 5 μm of d50 of the tested powders A, B, and C.

| Powder | Wt % |
|---|---|
| Powder A | 79.8 |
| Powder B | 70.7 |
| Powder C | 31.7 |

### Density and Flow Characteristics

Apparent density and flow characteristics are reported to provide useful information on how the powders will pack in a loose state as in the case of powder layer spreading during AM processing before the layer is compacted by a roller [Spierings, A. B. et al., Powder flowability characterization methodology for powder-bed-based metal additive manufacturing, Progress in Additive Manufacturing, 1 (2016) 9-20.]. Table 5 presents the flow characteristics of powders A, B, and C, obtained by the Hall and Carney funnels. The measured flow times under the Hall and Carney funnels indicate no statistical difference between powders A and B. In contrast, powder C shows a lack of flowability through the Hall funnel, while for the Carney funnel, the measured flow corresponds to 15.3±0.4 s for 50 g of powder. The results obtained by both techniques indicate that powders A and B show better flow behavior than powder C.

TABLE 5
Powder flowability of powders A, B, and
C determined by Hall and Carney funnels.

| Powder | Hall flow (s/50 g) | Carney flow (s/50 g) |
|---|---|---|
| Powder A | 33.0 ± 0.4 | 6.1 ± 0.01 |
| Powder B | 32.7 ± 0.7 | 6.1 ± 0.01 |
| Powder C | No flow | 15.3 ± 0.4 |

Table 6 summarizes the apparent density values obtained by three different techniques recommended for powder metallurgy, i.e., Hall funnel, Carney funnel, and Arnold meter. Powder A presents the highest apparent density, followed by powder B and powder C. It is known that the Hall funnel is not able to quantify the apparent density of non-flowing powders. However, alternative techniques used in the powder metallurgy field, such as the Carney funnel and Arnold meter, are able to provide consistent values with a difference of approximately 1% between each technique. Theoretical densities used for the calculation of the apparent density were 2.70 g/cm³ and 2.68 g/cm³ for powders A and B, and powder C respectively.

TABLE 6
Apparent density of powders A, B, and C estimated by the
Hall and Carney funnels as well as the Arnold meter.

| | Hall apparent | Carney apparent | Arnold apparent |
|---|---|---|---|
| Powder | density (%) | density (%) | density (%) |
| Powder A | 54.8 ± 0.50 | 55.5 ± 0.06 | 56.3 ± 0.11 |
| Powder B | 53.3 ± 0.50 | 54.8 ± 0.01 | 55.8 ± 0.11 |
| Powder C | — | 51.6 ± 0.36 | 52.7 ± 0.23 |

### Spread Density

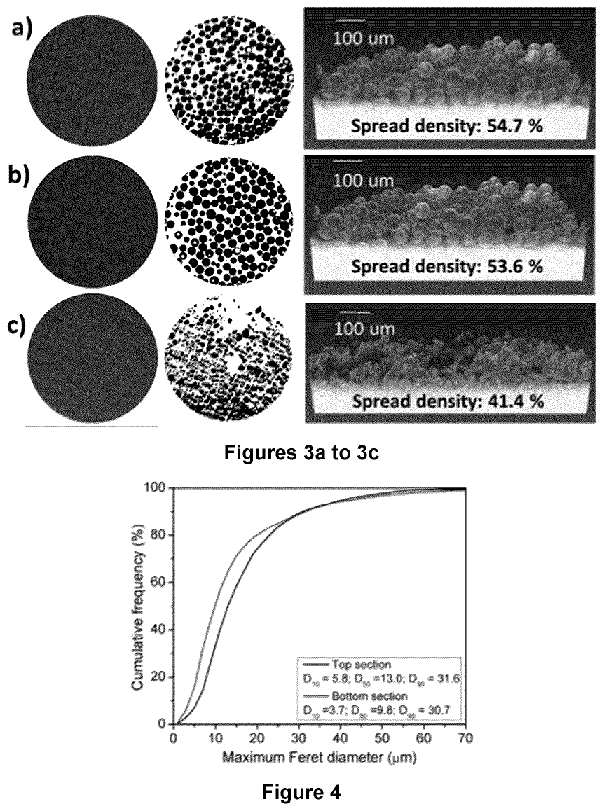

The laser-powder interactions during LPBF processing influence the melt pool dynamics. Ideally, during powder spreading, a homogeneous powder bed with high packing density would be preferred. In order to evaluate the spread density, X-Ray micro-computed tomography was used. This technique provides a 3D visualization of particles which allows to determine the internal porosity as well as the packing density of powders contained in a powder bed, commonly known as spread density. FIGS. 3a to 3c depicts the 2D and 3D reconstructed images of powders A, B, and C, respectively. Trapped gas is evident in powders A and B with a volume fraction of 0.7 and 0.2% respectively while no evidence of porosity was found in powder C. Trapped gas in the powder feedstock is an important quality parameter since it has been demonstrated that, during AM processing, trapped gas is released into the molten material leading to rounded residual porosity in the as-built part [Cunningham, R. et al., Analyzing the effects of powder and post-processing on porosity and properties of electron beam melted Ti-6Al-4V, Materials Research Letters, 5 (2017) 516-525].

The spread density obtained from powders A and B is consistent with the apparent density measurements obtained by the Hall, Carney, and Arnold meter methods with 54.7 and 53.6%, respectively. However, the apparent density obtained for powder C using CT scanning differs significantly from the traditional methods.

### Specific Surface Area and Surface Roughness

Measurements of the specific surface area of powders A, B and C were conducted using Inverse Gas Chromatography and are presented in Table 7 below. Powders A and B show values of specific surface area about 10 times lower than powder C. A calculation of the specific surface area of powders A and B was performed to account for the packing density and PSD and resulted in 0.035 m²/g, which is greater than the measured values of 0.021 m²/g and 0.025 m²/g. However, this theoretical value is still much lower than the measured value for powder C.

TABLE 7
Specific surface area of the tested powders A, B, and C

| Powder | Specific surface area (m²/g) |
|---|---|
| Powder A | 0.025 |
| Powder B | 0.021 |
| Powder C | 0.250 |

The surface roughness of the particles was determined by mercury porosimetry, which provides the volume, size and surface area of the pores. Considering the fact that particles do have open pores, any mercury intrusion could be associated with surface roughness and irregularities (peaks and valleys). The Washburn equation,

ΔP·r=−2·γ cos Θ where γ is surface tension, r is the capillary radius, Θ is the angle of contact and ΔP is the applied pressure (above ambient), is the principal equation used in mercury porosimetry.

This equation is based on equilibrium between the force or work required to move mercury into and out of the capillary pore. The contact angle of mercury and aluminium is greater than 90° and mercury does not wet aluminum. Thus, ΔP is positive and a pressure greater than ambient must be applied to the liquid mercury to fill the valleys on the surface. Surface tension and contact angle are constant at a constant temperature, thus as the pressure increases, the mercury will intrude progressively into narrower pores.

The low pressure measurement consisted of cell evacuation, filling with mercury and intrusion. The sample was weighed to the nearest 0.001 g and put in a 6 cm³ cell, which was sealed by grease and tightened. The penetrometer cell containing the sample was installed horizontally in the mercury porosimeter (Micromeritics, AutoPore IV 9500). Air was evacuated from the sample cell until a pressure of 50 tmHg was obtained. The open end of the cell stem was submerged under mercury and nitrogen gas above the mercury forced the liquid into the stem to fill the voids around the sample. Pressure was gradually increased to 0.0012 MPa to intrude the mercury into the voids between the particles. The change in the length of mercury column in the cell stem was transformed to the intruded volume. Then the penetrometer was transferred to the high pressure chamber where pressure was increased gradually to 413.7 MPa and the intruded volume was recorded. At this point, depressurization started and pressure was gradually decreased to 0.12 MPa to extrude the mercury.

A powder similar to powders A and B, but with a d50 closer to the unsieved powder C was produced (nominal size range 45-53 μm) and assessed via mercury porosimetry, along with the unsieved powder C. Each powder was assessed twice. Powder C (unsieved) had a surface area between 0.138 m²·g⁻¹ and 1.070 m²·g⁻¹, whereas the powder representative of powders A and B, but with the smaller d₅₀ had a surface area between 0.044 m²·g⁻¹ and 0.06 m²·g⁻¹. These results are congruent with those in Table 7, which also show an order of magnitude difference in surface area. For the two repeats of powder A/B and one of the tests with powder C skeletal densities of 2.65 g cm⁻¹ and 2.61 g cm⁻¹ (respectively) were achieved, which are both close to the theoretical density of the material. For the other test with powder C—that registered a specific surface area of 0.138 m²·g⁻¹—the skeletal density was only 2.12 g cm⁻¹, likely indicating incomplete intrusion. Powder C is not very homogeneous, so it is possible that the fine particles agglomerated and formed internal voids that were not measured.

### Particle Segregation in a Powder Bed

Differences in local PSD within a powder bed have the potential to produce local variation of powder bed densities during manufacturing and process instability in terms of melt pool signature [Boley, C. D. et al., Calculation of laser absorption by metal powders in additive manufacturing, Appl. Opt., 54 (2015) 2477-2482]. In order to study the particle segregation during powder coating, a layer of 50 μm of powder C was spread over a previously burned Al plate and the PSD was analyzed at different locations over the plate. FIG. 4 depicts the PSD of samples from powder C collected from the top and bottom sections of the Al plate which represent the locations where the powder spreading starts and ends, respectively. Differences in PSD between the top and bottom section of the powder bed were observed. Large particles with D₅₀ of 13.0 μm are segregated in the region where spreading starts, while smaller particles with D₅₀ of 9.8 μm segregate at the end of the powder bed.

### Moisture Sorption Characteristics

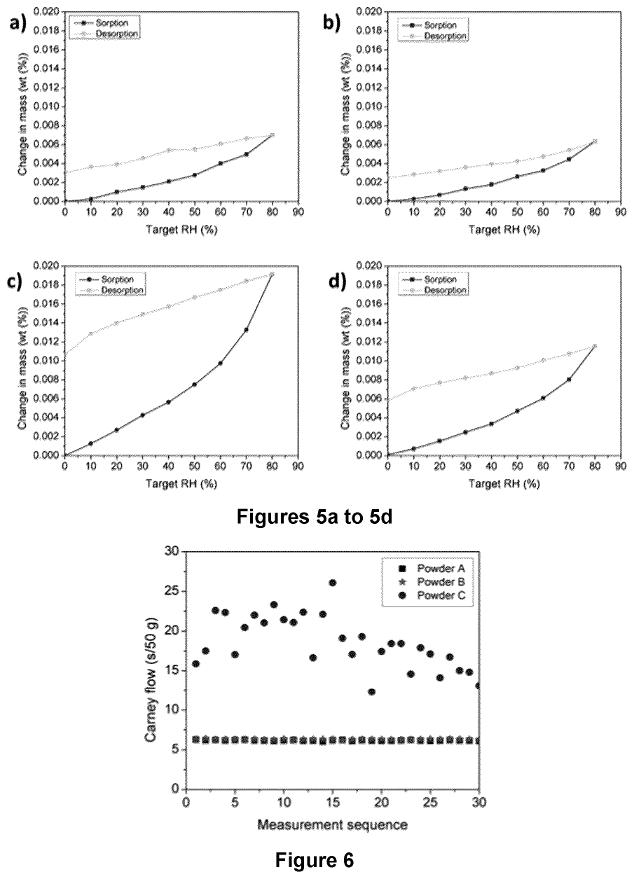

The moisture sorption test results of powders A, B, and C determined by means of DVS tests are shown in FIGS. 5a to 5c. In order to see the effect of PSD on the moisture sorption capabilities, powder C was sieved to obtain a PSD D₁₀=48 μm, D₅₀=65 μm, and D₉₀=92 μm which is similar to powders A and B. The DVS isotherm for the sieved powder is shown in FIG. 5d. Powder C has a significantly higher average moisture sorption when compared to powders A and B. By eliminating the fine particles present in powder C, the degree of moisture sorption for the sieved powder C is reduced. The results provided in the Table 8 indicate that even when sieved, powder C has a larger degree of moisture sorption than powders A and B. It was shown above that powders A and B also have a lower content of fines and a highly spherical morphology in comparison with powder C, which suggests a synergistic effect between these parameters that leads to a lower moisture sorption. Low moisture sorption is typically associated with particles having a thick passivation layer, but surprisingly, it is shown in Table 9 that powders A and B have a passivation layer thinner than powder C.

TABLE 8
Degree of moisture sorption of the tested powders A, B, and C

| Powder | Change in mass wt % |
|---|---|
| Powder A | 0.007 |
| Powder B | 0.006 |
| Powder C | 0.019 |
| Powder C (sieved) | 0.012 |

TABLE 9
Passivation layer thickness of the tested powders A, B, and C

| Powder | Thickness (nm) |
|---|---|
| Powder A | 4.36 |
| Powder B | 4.34 |
| Powder C | 10.18 |

### Multiple Cycle Flowability Test

In order to evaluate the effect of humidity on powder flow, a multiple cycle flowability test was carried out at a RH of 40% using 50 g of dried powders. FIG. 6 shows the Carney flow corresponding to powders A, B, and C as a function of measurement sequence. No significant variation in flow was observed between powders A and B which remains stable over time with an average flow of 6 s. However, powder C shows a strong variation in flow within the first 5 minutes after removal from the oven. During this time, the flow time increased from 16 s to approximately 22 s to subsequently decrease continuously until reaching a flow time of 14 s after 30 consecutive measurements. The moisture sorption characteristics of tested powders depicted by the previous DVS analysis plays an important role in the powder flowability. The high surface area present in powder C due to the contribution of fine particles, increases the amount of adsorbed water which decreases the powder flow and/or contributes to the development of powder agglomerates. After the first 5 minutes, it is believed that the observed increment in flowability might be related to the breaking up of the agglomerates due to the shearing strength produced by continuously flowing the same powder.

### Particle Cohesiveness

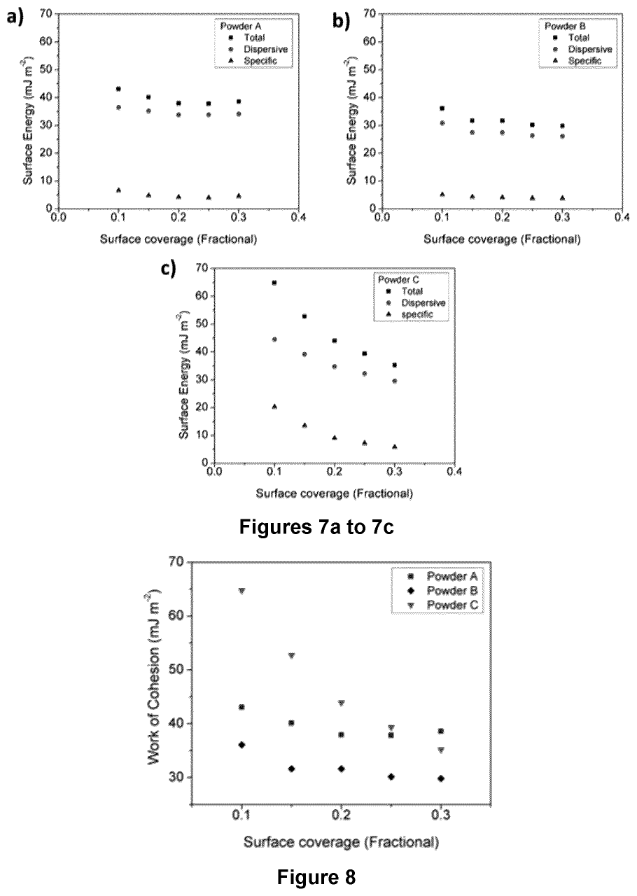

FIGS. 7a to 7c show the surface energy as a function of surface coverage for powders A, B, and C, respectively. For all powders, the dispersive component of the surface energy is the dominant component. It can be seen that powder C displays a much larger degree of surface energy heterogeneity, as indicated by a decrease in surface energy (dispersive and specific, leading to a decrease in total) with increasing surface coverage. The surface energy of powder C is also much greater than the other two powders at low surface coverage, which is likely to be due to the fine material contained in powder C having a higher energy. Powders A and B have a much lower degree of surface energy heterogeneity, with the general trend of powder A having the greater surface energy across the entire surface.

The work of cohesion gives an indication of the natural affinity of the powders for agglomeration. FIG. 8 shows the Work of Cohesion (W_{co}) of powders A, B, and C. It can be seen that, at low surface coverages, powder C has a much greater W_{co}, which is most likely dominated by the fine material. Thus, the presence of fine powders favors cohesion giving rise to powder agglomeration. From this, it would indicate that powder C would have the lowest flowability.

### Static and Dynamic Angle of Repose

During AM layer spreading, the powder is typically deposited in two steps: (1) the powder is piled up by gravity in front of a re-coating blade, and (2) the powder is spread over the powder bed by the horizontal movement of the re-coater. The first recoating step might be properly represented by static flow tests while the second step, which is subjected to shear stresses due to the horizontal movement of the re-coater, might be better represented by a dynamic angle of repose. The static flow behavior for each powder characterized by the conical angle of repose is summarized in Table 10. It can be seen that the powder containing spherical and coarser particles, powder B, has the lowest static angle of repose, followed by powder A. In contrast, powder C which contains the larger amount of fines and irregular particles, has the highest static angle of repose.

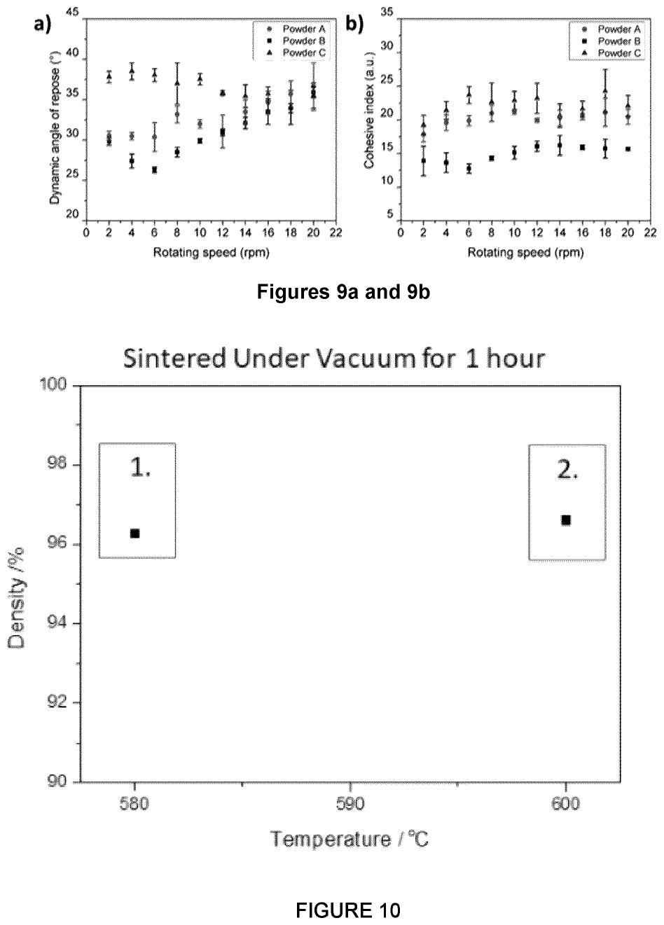

FIG. 9a presents the evolution of the dynamic angle of repose as a function of the rotating speed for powders A, B, and C. Dynamic powder flow measurements clearly show reproducible differences between the tested powders up to a rotating speed of 14 rpm. Below this speed, spherical and coarse particles show the lowest dynamic angles, while fine and non-spherical particles show the highest angles of repose. At rotating speeds higher than 14 rpm, no statistical difference is observed. Specifically, powders A and B present a typical shear thinning behavior due to the slipping layers passing each other at rotating speeds between 2 and 6 rpm with a minimum dynamic angle of 26° and 30°, respectively. At rotating speeds higher than 6 rpm, there is a transition from shear thinning to shear thickening on both powders associated to the breakdown of layers and the formation of large aggregates [T. Hao, Analogous viscosity equations of granular powders based on Eyring's rate process theory and free volume concept, RSC Advances, 5 (2015) 95318-95333]. The maximum angle of repose was obtained at 20 rpm for powders A and B with values of 37° and 36°, respectively. In contrast, powder C presents the highest dynamic angle of repose at lower rotating speeds, i.e., between 2 and 6 rpm, with a maximum value of 38°. After 6 rpm, powder C shows a slight thinning behavior decreasing its angle of repose to an average minimum of 35° between 14 and 20 rpm. A quantification of cohesion occurring in the powders during drum rotation, can be carried out by the use of a cohesive index which is determined from the fluctuations of the avalanche interface [Lumay, G. et al., Measuring the flowing properties of powders and grains, Powder Technol., 224 (2012) 19-27.]. A higher number of cohesive index represents higher cohesion, while a lower cohesion index represents lower cohesion between particles. FIG. 9b depicts the evolution of the cohesive index as a function of the rotating speed for the tested powders. The coarser and spherical powder B produces the lowest cohesion index, whereas the finest and non-spherical powder C, presents the highest cohesion index. It is clearly seen that the particle cohesion of the Al powders is affected by the surface properties and PSD. The high surface energy and moisture sorption characteristics measured in powder C, compared with powders A and B, evidently increases the particle cohesiveness.

TABLE 10
Static angle of repose of particles A, B, and C

| Powder | Static angle of repose [°] |
|---|---|
| Powder A | 30 ± 4 |
| Powder B | 26 ± 3 |
| Powder C | 39 ± 4 |

### Total Oxygen Content

Total oxygen content of powder A, B and C was measured and the values are reported in Table 11. One can hypothesize that the higher oxygen content of powder C is due to the presence of fine particles, which have a detrimental impact on the overall surface area-to-volume ratio. Furthermore, it should be noted that powders A and B had been stored under suboptimal conditions prior to their oxygen analysis.

TABLE 11
Total oxygen content for powders A, B and C

| Powder | Total Oxygen (ppm) |
|---|---|
| Powder A | 550 |
| Powder B | 500 |
| Powder C | 1500 |

The characteristics of powders A and B, such as narrow-sized PSD, high sphericity, good flowability, and lack of satellite particles, produce a homogeneous powder bed with a high apparent density similar to that obtained by traditional methods. However, the presence of a large amount of fines and irregular particles such as the ones present in powder C, hardens the powder flow behavior resulting in inhomogeneous powder bed with low apparent density not comparable with traditional test methods.

### Sintering

Powder A and C were sintered in absence of sintering aid and without any compaction step. More specifically, powders A and C were poured in a crucible and inserted in a furnace to be heated for one hour under vacuum at a first temperature of 580° C. and a second temperature of 600° C. Density of the sintered part was measured after sintering at the first temperature (data 1) and at the second temperature (data 2); and the results are presented in FIG. 10. No data is presented for powder C as no sintering was achieved and the formed part crumbled. FIG. 10 shows that forming a part with at least 95% density can be achieved by sintering the presently defined metal-based powder without the use of a sintering aid or a compaction step.

In conclusion, it can be appreciated from the above that powders A and B have specific parameter values that provide good performance when used in AM processes, AM consolidated parts and sintered parts. Indeed, it was shown that the powders A and B consist essentially of metal-based particles having an average sphericity greater than 0.95, and are substantially fines-free with less than 8,000,000 particles per gram of the metal-based particles having a diameter smaller than or equal to about 15 μm. Powders A and B showed a low moisture sorption. Low moisture sorption is typically achieved with particles having a thick passivation layer. However, powders A and B have a passivation layer thickness about half of that of powder C.

1. An additive manufacturing powder comprising metal-based particles wherein less than 20, 000, 000 of the metal-based particles per gram of the metal-based particles have a diameter smaller than or equal to 15 μm; and the metal-based particles have at least one of:
a) an average aspect ratio greater than or equal to 0.95;
b) an average roundness greater than or equal to 0.95; and
c) an average Krumbein sphericity greater than or equal to 0.95.

2. The additive manufacturing powder as claimed in claim 1, comprising metal-based particles wherein:
less than 8,000,000 of the metal-based particles per gram of the metal-based particles have a diameter smaller than or equal to 15 μm;
less than 1,000,000 of the metal-based particles per gram of the metal-based particles have a diameter between 10 μm and 15 μm, less than 2,000,000 of the metal-based particles per gram of the metal-based particles have a diameter between 5 μm and 10 μm, and less than 5,000,000 of the metal-based particles per gram of the metal-based particles have a diameter smaller than 5 μm;
less than 500,000 of the metal-based particles per gram of the metal-based particles have a diameter between 10 μm and 15 μm, less than 1,000,000 of the metal-based particles per gram of the metal-based particles have a diameter between 5 μm and 10 μm, and less than 3,000,000 of the metal-based particles per gram of the metal-based particles have a diameter smaller than 5 μm; or
less than 300,000 of the metal-based particles per gram of the metal-based particles have a diameter between 10 μm and 15 μm, less than 700,000 of the metal-based particles per gram of the metal-based particles have a diameter between 5 μm and 10 μm, and less than 2,500,000 metal-based particles per gram of the metal-based particles have a diameter smaller than 5 μm.

3.-4. (canceled)

5. The additive manufacturing powder as claimed in claim 1, wherein the additive manufacturing powder consists essentially of the metal-based particles.

6.-8. (canceled)

9. The additive manufacturing powder as claimed in claim 1, wherein the average aspect ratio of the metal-based particles is greater than or equal to about 0.985.

10.-11. (canceled)

12. The additive manufacturing powder as claimed in claim 1, wherein the average Krumbein sphericity of the metal-based particles is greater than 0.999.

13.-14. (canceled)

15. The additive manufacturing powder as claimed in claim 1, wherein the average Wadell roundness of the metal-based particles is greater than or equal to 0.991.

16. (canceled)

17. The additive manufacturing powder as claimed in claim 1, wherein the metal-based particles of the powder have a dimensionless particle size distribution width greater than 10.

18. The additive manufacturing powder as claimed in claim 1, wherein the metal-based particles of the powder have an average apparent density greater than or equal to 53%.

19.-20. (canceled)

21. The additive manufacturing powder as claimed in claim 18, wherein the powder has a ratio of an average spread density to the average apparent density greater than 90%.

22.-23. (canceled)

24. The additive manufacturing powder as claimed in claim 1, wherein the metal-based particles of the powder have a mass-median-diameter (d50) and at least 70 wt % of the metal-based particles of the powder are within 5 μm of the mass-median-diameter (d50) and/or at least 99.6 wt % of the metal-based particles of the powder are within 20 μm of the mass-median-diameter (d50).

25. (canceled)

26. The additive manufacturing powder as claimed in claim 24, wherein at least 99.6 wt % of the metal-based particles of the powder are within 15 μm of the mass-median-diameter (d50) or within 10 μm of the mass-median-diameter (d50).

27. (canceled)

28. The additive manufacturing powder as claimed in claim 24, wherein the mass-median-diameter (d50) is between 45 μm to 90 μm, or is 125 μm.

29. (canceled)

30. The additive manufacturing powder as claimed in claim 1, wherein the metal-based particles of the powder are characterized by a Hall flow lower than or equal to 40 seconds per 50 grams.

31. (canceled)

32. The additive manufacturing powder as claimed in claim 1, wherein the metal-based particles of the powder are characterized by a Carney flow lower than or equal to 7 seconds per 50 grams.

33. The additive manufacturing powder as claimed in claim 1, wherein the metal-based particles of the powder are characterized by a specific surface area between 0.02 and 0.2 m²/g.

34. (canceled)

35. The additive manufacturing powder as claimed in claim 1, wherein the metal-based particles of the powder have an average degree of moisture sorption less than 0.006 wt %.

36. The additive manufacturing powder as claimed in claim 1, wherein the metal-based particles comprise an outer metal oxide layer and an average thickness of the outer metal oxide layer of the metal-based particles is less than 5 nm.

37. The additive manufacturing powder as claimed in claim 1, wherein the metal-based particles are formed by an atomization process.

38.-40. (canceled)

41. A consolidated part produced via additive manufacturing of the powder as defined in claim 1.

42. A process for manufacturing a part comprising:
providing a metal-based powder as defined in claim 1, and
manufacturing the part from the metal-based powder using at least one of powder bed fusion, directed energy deposition, binder jetting, cold spray, metal injection molding, hot isostatic pressing and sintering.

43.-79. (canceled)
